(19) United States
(12) Patent Application Publication
(10) Pub. No.: US 2022/0021202 A1
(43) Pub. Date: Jan. 20, 2022

(54) Self-adaptive Positive-sequence Current Quick-break Protection Method for Petal-shaped Power Distribution Network Trunk Line

(71) Applicants: Tianjin University, Tianjin (CN); State Grid Hebei Electric Power Co. Ltd, Shijiazhuang City (CN); State Grid Corporation of China, Beijing (CN); China Electric Power Research Institute Co., Ltd, Beijing (CN)

(72) Inventors: Yong-li Li, Tianjin (CN); Weikang Wang, Chengdu (CN); Xiaolong Chen, Tianjin (CN); Zigang Zhao, Shijiazhuang City (CN); Qiang Wang, Shijiazhuang City (CN); Jiangbo Ren, Shijiazhuang City (CN); Fengran Chang, Shijiazhuang City (CN); ShaoBo Geng, Shijiazhuang City (CN); Yakun He, Shijiazhuang City (CN); Zhongqing Li, Beijing (CN); Guosheng Yang, Beijing (CN); Shuai Jiang, Beijing (CN)

(21) Appl. No.: 17/379,082

(22) Filed: Jul. 19, 2021

(30) Foreign Application Priority Data
Jul. 20, 2020 (CN) 2020107016754

(51) Int. Cl. H02H 7/26; H02H 1/00; G05B 19/048

(52) U.S. Cl. CPC H02H 7/26; H02H 1/0007; G05B 2219/2639; G05B 19/048; H02H 1/0092

(57) ABSTRACT

The invention relates to a self-adaptive positive-sequence current quick-break protection method for a petal-shaped power distribution network trunk line. The method comprises the following steps: step 1, calculating a positive-sequence voltage phasor and a positive-sequence current amplitude at a protection installation position when a fault occurs, acquiring and storing a positive sequence impedance value of a protected line; judging a fault type, and judging a fault direction; step 2, when a fault direction element judges that a fault occurs in the forward direction, selecting a self-adaptive current quick-break protection setting formula according to the fault type, and when positive sequence current measured by protection is larger than a protection setting value, judging that the protected line has a short-circuit fault, and making a circuit breaker trip quickly. Compared with the prior art, the method provided by the invention has enough sensitivity and does not change along with the change of the line length and the system operation mode.

### CROSS REFERENCE TO RELATED APPLICATION

The invention relates to the field of relay protection of electric power system distribution networks, and relates to a single-ended self-adaptive current protection method of a distribution network, in particular to a self-adaptive positive-sequence current quick-break protection method for a petal-shaped power distribution network trunk line.

### BACKGROUND OF THE INVENTION

With the improvement of users' requirements for the reliability of the power distribution network, petal-shaped grid structures are gradually applied to the distribution network, and petal-shaped distribution network protection is increasingly important to the safety and reliability of the power system. The petal-shaped urban power distribution network is combined to operate, the grid structure is special, and the power distribution network trunk line is relatively short. While a short-circuit fault occurs, fault current is large, which seriously threatens the safe and reliable operation of the power distribution network system. Therefore, petal-shaped distribution network protection is very important to ensure the reliability and safety of the modern power distribution network system.

At present, the petal-shaped power distribution network trunk line uses optical fiber current differential protection as the main protection, and overcurrent protection as the backup protection. However, the current differential protection relies heavily on the synchronization of the communication data and the reliability of the communication channel Once a communication problem occurs, failure or malfunction of optical fiber differential protection may be caused. Overcurrent protection has the problems of high time delay and poor selectivity. The different fault locations may cause the protection to fail to accurately identify the fault line and expand the removal range. Therefore, overcurrent protection is not conducive to ensuring the electric energy supply of the load in the petal-shaped power distribution network.

In view of the problems existing in busbar power distribution network line protection, many scholars focus on self-adaptive current protection in the research of single power distribution network protection. “Self-adaptive Relay Protection and Its Prospects” proposes self-adaptive current protection that calculates the backside impedance of the protection, but when the line is short, there is a problem of insufficient sensitivity. For the petal-shaped power distribution network, there is no single-ended quantity protection that can act quickly and has sufficient sensitivity. Therefore, in order to ensure the reliability and safety of the power supply of the petal-shaped power distribution network trunk line, it is of great significance to study new current protection based on single-ended quantity information.

### SUMMARY OF THE INVENTION

To solve the problems, the invention discloses a self-adaptive positive-sequence current quick-break protection method for a petal-shaped power distribution network trunk line. This method is based on the relationship between the positive sequence voltage and the positive sequence current at the protection installation position during a phase-to-phase short-circuit fault and the impedance value of the protected line, combined with power directional elements to construct single-ended current quantity protection criterion for the petal-shaped distribution network trunk line to quickly identify the short-circuit fault within the protection range. It not only overcomes the problem of insufficient sensitivity of the existing current quick-break protection, but also has the advantage of not being affected by changes in a system operation mode and a grid structure.

To solve the technical problems, the invention adopts the following technical scheme:

A self-adaptive positive-sequence current quick-break protection method for a petal-shaped power distribution network trunk line comprises the following steps:

step 1, calculating a positive-sequence voltage phasor \dot{U}₁ and a positive-sequence current amplitude I₁ of a protection installation position when a fault occurs based on the obtained voltage power frequency quantity \dot{U}ₐₚᵣₑ, \dot{U}_{bpre}, \dot{U}_{cpre} of each phase during normal operation, voltage power frequency quantity \dot{U}ₐ, \dot{U}_{b}, \dot{U}_{c} of each phase and current power frequency quantity İₐ, İ_{b}, İ_{c} of each phase when a fault occurs;

obtaining and storing the positive sequence impedance value Z_{L1} of the protected line;

utilizing the fault component of each phase current at the protection installation position to determine the fault type; at the same time, utilizing the power directional element adopting a 90° wiring mode to determine the fault direction based on the obtained fault type;

step 2, selecting a self-adaptive positive sequence quick-break current protection setting formula according to the fault type when the fault directional element is judged to have a fault in the forward direction, and judging that the protected line has short-circuit fault and making a circuit breaker trip quickly when the protection detects that the positive sequence current is greater than the protection setting value.

Moreover, the self-adaptive positive sequence quick-break current protection setting formula is as follows:

$${I}_{Z D Z} = \vert \frac{{K}_{r e l} {\dot{U}}_{P}}{{Z}_{L 1}} \vert$$

where, \dot{U}_{P}=\dot{U}₁ when a three-phase short-circuit fault occurs, \dot{U}_{P}=\dot{U}₁−(\dot{U}ₓₚᵣₑ/2) when a two-phase phase-to-phase short-circuit fault occurs, \dot{U}ₓₚᵣₑ is voltage power frequency quantity of the non-faulty phase X during normal operation, and Kᵣₑₗ is a reliability coefficient.

Moreover, the voltage amplitude value is \dot{U}ₓₚᵣₑ during normal operation; and a voltage measurement amplitude value 40 ms before the fault occurs is taken.

Moreover, the method for judging the fault type is as follows:

when (m|İ_{mgC}|≤|İ_{mgA}|)∩(m|İ_{mgC}|≤|İ_{mgB}|), the fault type is AB two-phase short-circuit fault;

when (m|İ_{mgA}|≤|İ_{mgB}|)∩(m|İ_{mgA}|≤|İ_{mgC}|), the fault type is BC two-phase short-circuit fault;

when (m|İ_{mgB}|≤|İ_{mgC}|)∩(m|İ_{mgB}|≤|İ_{mgA}|), the fault type is CA two-phase short-circuit fault;

when the above conditions are not met, the fault type is ABC three-phase short-circuit fault;

where, İ_{mgA}, İ_{mgB}, İ_{mgC} are separately the fault components of A-phase, B-phase and C-phase at the protection installation position respectively, and m is the setting coefficient.

Moreover, value range of the setting coefficient m is 4˜8.

Moreover, criterion of the power direction is as follows:

$$- 180 ° + φ \leq arg \frac{{\dot{U}}_{ϕϕ}}{{\dot{I}}_{ϕ}} \leq φ$$

where, \dot{U}_{ϕϕ} and İ_{ϕ} are separately voltage and current phasors of the protection installation position respectively, Φ refers to A, B, C; and φ is the line impedance angle.

Moreover, the reliability coefficient Kᵣₑₗ is 1.2.

The advantages and beneficial effects of the invention are as follows:

The self-adaptive positive-sequence current quick-break protection method for the petal-shaped power distribution network trunk line is disclosed based on the relationship between the positive sequence current and the positive sequence voltage at the protection installation position when the protected line fails in the forward direction. Compared with the existing methods, the method has sufficient sensitivity and does not change with changes in line length and system operation mode.

### BRIEF DESCRIPTION OF THE FIGURES

FIG. 1 is a schematic diagram of a 10 kV petal-shaped power distribution network.

FIG. 2 is a two-phase phase-to-phase short-circuit fault composite sequence network diagram.

FIG. 3 is an equivalent circuit when three-phase short-circuit fault occurs

Explanation of labels in the figures is as follows:

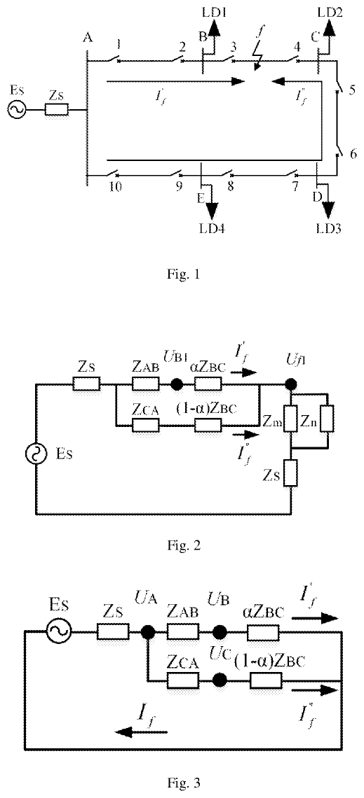

In FIG. 1, E_{S} is the equivalent phase potential of the system, Z_{S} is the equivalent internal impedance of the system, A, B, C, D, and E represent the bus, f represents the fault point, 1, 2, 3, 4, 5, 6, 7, 8, 9, 10 are the serial numbers of the protection, LD1, LD2, LD3, LD4 represent the load, and I′_{f} and I″_{f} are the fault currents on both sides of the fault point.

In FIG. 2, U_{B1} represents the positive sequence voltage at the B bus, U_{f1} represents the positive sequence voltage at the fault point, I′_{f1} and I″_{f1} are the positive sequence currents on both sides of the fault point; Zₘ=Z_{AB}+αZ_{BC}, Zₙ=(1−α)Z_{BC}+Z_{CA}.

In FIG. 3, Z_{AB} is the impedance of line AB, Z_{BC} is the impedance of line BC, Z_{CA} is the impedance of line CDA, α is the ratio of the distance between the fault point and bus bar B to the total length of the BC line, U_{A}, U_{B}, and U_{C} are phase voltages on busbars A, B and C, and I_{f} is the current of the fault point.

### DETAILED DESCRIPTION OF THE PREFERRED EMBODIMENTS

The invention will be further described in detail below through specific examples. The following examples are only descriptive and not restrictive, and the protection scope of the invention cannot be limited by this.

A self-adaptive positive-sequence current quick-break protection method for a petal-shaped power distribution network trunk line utilizes the relationship between the positive sequence current and the positive sequence voltage at the line protection installation position to derive the positive sequence current quick-break setting value, and compares the magnitude of the positive sequence current with the setting value to realize the judgment of short-circuit fault, the specific steps are as follows:

(1) As shown in FIG. 1, it is a schematic diagram of a 10 kV petal-shaped power distribution network specifically applied in this example. A voltage acquisition device at the protection position acquires the voltage power frequency quantity \dot{U}ₐₚᵣₑ, \dot{U}_{bpre}, \dot{U}_{cpre} of each phase during normal operation and the voltage power frequency quantity \dot{U}ₐ, \dot{U}_{b}, \dot{U}_{c} of each phase when a fault occurs, and a current acquisition device acquires current power frequency quantity İₐ, İ_{b}, I̅_{c} of each phase. A data processing device calculates the positive sequence voltage phasor \dot{U}₁ and the positive sequence current amplitude I₁ at the protection installation position while a fault occurs.

The positive sequence impedance value Z_{L1} of the protected line is stored in the protection device in advance.

(2) The fault components of each phase current at the protection installation position are used to distinguish the three-phase short-circuit fault from the two-phase short-circuit fault. The power directional element adopting the 90° wiring mode is utilized to judge the direction of the fault.

(3) The self-adaptive positive sequence quick-break current protection setting formula is selected according to the fault type when the fault directional element is judged to have a fault in the forward direction, and the protected line is judged to have a short-circuit fault and a circuit breaker is made to trip quickly when the protection detects that the positive sequence current is greater than the protection setting value. The self-adaptive positive sequence quick-break current protection setting formula is as follows:

$${I}_{Z D Z} = \vert \frac{{K}_{r e l} {\dot{U}}_{P}}{{Z}_{L 1}} \vert$$

where, \dot{U}_{P}=\dot{U}₁ when a three-phase short-circuit fault occurs, \dot{U}_{P}=\dot{U}₁−(\dot{U}ₓₚᵣₑ/2) when a two-phase phase-to-phase short-circuit fault occurs, \dot{U}ₓₚᵣₑ is voltage power frequency quantity of the non-faulty phase X during normal operation, and Kᵣₑₗ is a reliability coefficient.

In the step (1), the voltage phase \dot{U}ₚᵣₑ during normal operation can be voltage measuring power frequency quantity 40 ms before a fault occurs.

In step (2), the fault type data are as shown in table 1 after zero-sequence current is determined.

TABLE 1
Identification of fault type

| Fault types | Criterions |
|---|---|
| AB two-phase short circuit | (m \| İ_{mgC} \|≤\| İ_{mgA} \|)∩(m \| İ_{mgC} \|≤\| İ_{mgB} \|) |
| BC two-phase short circuit | (m \| İ_{mgA} \|≤\| İ_{mgB} \|)∩(m \| İ_{mgA} \|≤\| İ_{mgC} \|) |
| CA two-phase short circuit | (m \| İ_{mgB} \|≤\| İ_{mgC} \|)∩(m \| İ_{mgB} \|≤\| İ_{mgA} \|) |
| ABC two-phase short circuit | The above conditions are not met. |

In the table, İ_{mgA}, İ_{mgB}, İ_{mgC} are the fault components of A-phase, B-phase and C-phase at the protection installation position respectively, and m is the setting coefficient with a value of 4˜8.

Power direction criterion is as follows:

$$- 180 ° + φ \leq arg \frac{{\dot{U}}_{ϕϕ}}{{\dot{I}}_{ϕ}} \leq φ$$

where, \dot{U}_{ϕϕ} and İ_{ϕ} are separately voltage and current phasors (Φ refers to A, B, C) at the protection installation position respectively, and φ is the impedance angle of the line.

In step (3), the reliability coefficient Kᵣₑₗ is 1.2.

The self-adaptive positive-sequence current quick-break protection based on the relationship between the positive sequence voltage and the positive sequence current at the protection installation position can identify the short-circuit fault that occurs on the protected line. The principle is as follows:

when a two-phase short-circuit fault occurs on the protected line, the fault composite sequence network diagram is as shown in FIG. 2. From FIG. 2, it can be seen that the positive sequence voltage and the positive sequence current at the protection 3 have the following relationship:

$${\dot{I}}_{f 1} = \frac{{\dot{U}}_{B 1} - \frac{{\dot{E}}_{s}}{2}}{α {Z}_{B C}} \qquad ( 1 )$$

In the actual power distribution network, the voltage drop on the impedance in the system and on the line impedance is ignored, Ė_{S} can be replaced with voltage \dot{U}ₚᵣₑ during normal operation of the non-faulty phase at the protection installation position.

In the case of a three-phase short-circuit fault, the fault equivalent circuit is as shown in FIG. 3. From FIG. 3, it can be seen that the positive sequence voltage and the positive sequence current at the protection 3 have the following relationship:

$${\dot{I}}_{f 1} = \frac{{\dot{U}}_{B 1}}{α {Z}_{B C}} \qquad ( 2 )$$

formula (1) and formula (2) can be combined to get the self-adaptive positive sequence current quick-break protection setting value:

$${I}_{Z D Z} = \vert \frac{{K}_{rel} {\dot{U}}_{P}}{{Z}_{L 1}} \vert \qquad ( 3 )$$

where, \dot{U}_{P}=\dot{U}₁ when a three-phase short-circuit fault occurs, \dot{U}_{P}=\dot{U}₁−(\dot{U}ₓₚᵣₑ/2) when a two-phase phase-to-phase short-circuit fault occurs, \dot{U}ₓₚᵣₑ is voltage power frequency quantity of the non-faulty phase X during normal operation, and Kᵣₑₗ is a reliability coefficient.

From formula (3), the protection range η of quick-break protection can be obtained:

$$η = \frac{1}{{K}_{rel}} \qquad ( 4 )$$

The protection range η is only related to the reliability coefficient Kᵣₑₗ, and has nothing to do with the line length and the operation mode of the system. When the reliability coefficient Kᵣₑₗ is 1.2, the protection range of quick-break current protection is η=83.3%.

The power direction criterion can be combined to obtain the operation criterion of the self-adaptive positive sequence current quick-break protection:

$$\{ \begin{matrix}{I}_{1} \geq {I}_{Z D Z} \\ - 180 ¦° + φ \leq arg \frac{{U}_{ϕϕ}}{{I}_{ϕ}} \leq φ\end{matrix} \qquad ( 5 )$$

It can be seen from formula (4) that when a fault occurs within the protection range of the protected line in the forward direction, the positive sequence fault current is greater than the setting value. Therefore, the self-adaptive positive sequence current quick-break protection can quickly and accurately identify short-circuit faults within the protection range.

In this example, PSCAD/EMTDC software is used in the 10 kV petal-shaped power distribution network system as shown in FIG. 1. The reference capacity of the system is 100 MVA, the reference voltage is 10.5 kV, and the internal impedance is 0.23Ω. The unit inductance and resistance of the cable line are X1=0.063 Ω/km and R1=0.047 Ω/km; the lengths of lines AB, BC, CD, DE, and EA are 2 km, 2 km, 1 km, 1 km, 2 km respectively. A load with a rated capacity of 2 MVA and a rated power factor of 0.9 is accessed to each node.

1) Fault Identification of Self-Adaptive Positive Sequence Current Quick-Break Protection

In order to verify the influence of different fault types and fault positions on the self-adaptive positive sequence current quick-break protection, the phase-to-phase short-circuit fault and the three-phase short-circuit fault occurred at the BC line α=0.1, 0.4, 0.6, 0.9 are simulated, and the Operation condition of the protection 3 is as shown in Table 1.

TABLE 1
Operation condition of BC line self-adaptive positive sequence current
quick-break protection

| | | Three-phase | | | Two-phase phase-to-phase | | |
|---|---|---|---|---|---|---|---|
| | | short-circuit fault | | | short-circuit fault | | |
| | | I_{ZDZ}/ | Iₗ/ | Operation | I_{ZDZ}/ | Iₗ/ | Operation |
| α | Protection | kA | kA | condition | kA | kA | condition |
| 0.1 | 3 | 1.511 | 12.480 | Operate | 0.759 | 6.308 | Operate |
| 0.4 | 3 | 5.124 | 10.649 | Operate | 2.565 | 5.393 | Operate |
| 0.6 | 3 | 6.941 | 9.623 | Operate | 3.473 | 4.881 | Operate |
| 0.9 | 3 | 8.965 | 8.290 | Nooperate | 4.458 | 4.214 | No operate |

It can be seen from Table 1:

Within α≤0.833 and I_{d1}>I_{ZDZ}, protection 3 will all operate; within α>0.833, protection 3 will not operate, and the quick-break protection at both ends of the line has a definite protection range, which can ensure sufficient sensitivity.

2) Influence of Line Length on Protection Range

In order to verify the influence of different line lengths on the range of self-adaptive positive-sequence current quick-break protection, the simulation results of CD line protection are shown in Table 2. In Table 2, β is the ratio of the distance between the fault point and bus C to the total length of the CD line.

TABLE 2
Operation condition of line protection 5

| | Three-phase | | | Two-phase phase-to-phase | | |
|---|---|---|---|---|---|---|
| | short-circuit fault | | | short-circuit fault | | |
| | I_{ZDZ}/ | Iₗ/ | Operation | I_{ZDZ}/ | Iₗ/ | Operation |
| β | kA | kA | condition | kA | kA | condition |
| 0.1 | 0.948 | 7.689 | Operate | 0.48 | 3.834 | Operate |
| 0.4 | 3.443 | 7.12 | Operate | 1.727 | 3.55 | Operate |
| 0.6 | 4.89 | 6.757 | Operate | 2.451 | 3.368 | Operate |
| 0.9 | 6.753 | 6.229 | No Operate | 3.382 | 3.104 | No Operate |

It can be seen by combining table 1 with table 2:

The line length does not affect the protection range of the self-adaptive positive sequence current quick-break protection. Even in a short line, the protection still has a certain protection range, which can ensure the sensitivity of the self-adaptive positive sequence current quick-break protection.

Although the examples and figures of the invention are disclosed for illustrative purposes, those skilled in the art can understand that various substitutions, changes and modifications are possible without departing from the spirit and scope of the invention and the appended claims. Therefore, the scope of the invention is not limited to the content disclosed in the examples and figures.

What is claimed is:

1. A self-adaptive positive-sequence current quick-break protection method for a petal-shaped power distribution network trunk line, comprising the following steps:
step 1, calculating a positive-sequence voltage phasor \dot{U}₁ and a positive-sequence current amplitude I₁ of a protection installation position when a fault occurs based on the obtained voltage power frequency quantity \dot{U}ₐₚᵣₑ, \dot{U}_{bpre}, \dot{U}_{cpre} of each phase during normal operation, voltage power frequency quantity \dot{U}ₐ, \dot{U}_{b}, \dot{U}_{c} of each phase and current power frequency quantity İₐ, İ_{b}, İ_{c} of each phase when a fault occurs;
obtaining and storing the positive sequence impedance value Z_{L1} of the protected line;
and utilizing the fault component of each phase current at the protection installation position to determine the fault type; at the same time, utilizing the power directional element adopting a 90° wiring mode to determine the fault direction based on the obtained fault type;
step 2, electing a self-adaptive positive sequence quick-break current protection setting formula according to the fault type when the fault directional element is judged to have a fault in the forward direction, and judging that the protected line has short-circuit fault and making a circuit breaker trip quickly when the protection detects that the positive sequence current is greater than the protection setting value.

2. The self-adaptive positive-sequence current quick-break protection method for the petal-shaped power distribution network trunk line according to claim 1, the self-adaptive positive sequence quick-break current protection setting formula is as follows:
$${I}_{Z D Z} = \vert \frac{{K}_{rel} {\dot{U}}_{P}}{{Z}_{L 1}} \vert$$
wherein, \dot{U}_{P}=\dot{U}₁ when a three-phase short-circuit fault occurs, \dot{U}_{P}=\dot{U}₁−(\dot{U}ₓₚᵣₑ/2) when a two-phase phase-to-phase short-circuit fault occurs, \dot{U}ₓₚᵣₑ is voltage power frequency quantity of the non-faulty phase X during normal operation, and Kᵣₑₗ is a reliability coefficient.

3. The self-adaptive positive-sequence current quick-break protection method for the petal-shaped power distribution network trunk line according to claim 1, wherein the voltage phase \dot{U}ₓₚᵣₑ during normal operation can be voltage measuring power frequency quantity 40 ms before a fault occurs.

4. The self-adaptive positive-sequence current quick-break protection method for the petal-shaped power distribution network trunk line according to claim 1, wherein
when (m|İ_{mgC}|≤|İ_{mgA}|)∩(m|İ_{mgC}|≤|İ_{mgB}|), the fault type is AB two-phase short-circuit fault;
when (m|İ_{mgA}|≤|İ_{mgB}|)∩(m|İ_{mgA}|≤|İ_{mgC}|), the fault type is BC two-phase short-circuit fault;
when (m|İ_{mgB}|≤|İ_{mgC}|)∩(m|İ_{mgB}|≤|İ_{mgA}|), the fault type is CA two-phase short-circuit fault;
when the above conditions are not met, the fault type is ABC three-phase short-circuit fault;
wherein, İ_{mgA}, İ_{mgB}, İ_{mgC} are separately the fault components of A-phase, B-phase and C-phase at the protection installation position respectively, and m is the setting coefficient.

5. The self-adaptive positive-sequence current quick-break protection method for the petal-shaped power distribution network trunk line according to claim 4, wherein the value range of the setting coefficient m is 4˜8.

6. The self-adaptive positive-sequence current quick-break protection method for the petal-shaped power distribution network trunk line according to claim 1, wherein the criterion of the power direction is as follows:
$$- 18 {0}^{∘} + φ \leq arg \frac{{\dot{U}}_{ϕϕ}}{{\dot{I}}_{ϕ}} \leq φ$$
where, \dot{U}_{ϕϕ} and İ_{ϕ} are separately voltage and current phasors of the protection installation position respectively, Φ refers to A, B, C; and φ is the line impedance angle.

7. The self-adaptive positive-sequence current quick-break protection method for the petal-shaped power distribution network trunk line according to claim 2, wherein the reliability coefficient Kᵣₑₗ is 1.2.
